(19) United States
(12) Patent Application Publication
(10) Pub. No.: US 2017/0191840 A1
(43) Pub. Date: Jul. 6, 2017

(54) Clustering of Geo-Tagged Media

(71) Applicants: Stefan B. KUHNE, San Jose, CA (US); Vermont T. Lasmarias, Fremont, CA (US); Quarup S. Barreirinhas, San Francisco, CA (US)

(72) Inventors: Stefan B. KUHNE, San Jose, CA (US); Vermont T. Lasmarias, Fremont, CA (US); Quarup S. Barreirinhas, San Francisco, CA (US)

(73) Assignee: Google Inc., Mountain View, CA (US)

(21) Appl. No.: 13/289,244

(22) Filed: Nov. 4, 2011

(51) Int. Cl. G06F 17/30

(52) U.S. Cl. CPC G01C 21/343

(57) ABSTRACT

Systems, methods, and computer storage mediums are provided for clustering various types of media objects received from one or more media sources. An exemplary method includes sorting the media objects based on a time value associated with each media object, wherein the time value represents when each corresponding media object was created. A delta between each two adjacent, sorted media objects is then determined. The delta includes a distance value that represents a difference between a geolocation associated with each two adjacent media objects. The delta also includes a velocity value that represents the velocity of travel between the geolocation associated with each two adjacent media objects. Once the delta is determined, a plurality of sorted media Objects are clustered into one or more segments based on the velocity value between the adjacent, sorted media objects.

### FIELD OF THE INVENTION

The field of the invention generally relates to organizing digital media.

### BACKGROUND

Systems currently exist that allow a user to collect and share digital media. These systems allow a user to share digital media that is uploaded and associated with the user's profile. These systems, however, do not allow a user to combine media with another user's digital media based on when and where the media was created.

### BRIEF SUMMARY

As a user or a group of users travel to, and about a destination, the digital media created during their travels are not easily merged together. The embodiments described herein provide systems and methods tor combining digital media from various media sources and from various user profiles based on when and where the digital media is created. The digital media from one or more users is clustered together based on the duration and the distance that occurs between creation of media objects. These embodiments allow a user to combine, in a meaningful way, digital media created along a trip.

The embodiments described herein include systems, methods, and computer storage mediums for clustering various types of media objects received from one or more media sources. An exemplary method includes sorting the media objects based on a time value associated with each media object, wherein the time value represents when each corresponding media object was created. A delta between each two adjacent, sorted media objects is then determined. The delta includes a distance value that represents a difference between a geolocation associated with each two adjacent media objects. The delta also includes a velocity value that represents the velocity of travel between the geolocation associated with each two adjacent media objects. Once the delta is determined, a plurality of sorted media objects are clustered into one or more segments based on the velocity value between the adjacent, sorted media objects.

Further features and advantages of the embodiments described herein, as well as the structure and operation of various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 illustrates an example system environment that may be used to cluster various types of media objects received from one or more media sources.

FIG. 2 is a flowchart illustrating an exemplary method that may be used to cluster various types of media objects received from one or more media sources.

FIG. 3 illustrates an exemplary group of segments that is the result of clustering media objects according to an embodiment.

FIG. 4 illustrates an example computer in which embodiments of the present disclosure, or portions thereof, may be implemented as computer-readable code.

### DETAILED DESCRIPTION

In the following detailed description, references to “one embodiment,” “an embodiment,” “an example embodiment,” etc., indicate that the embodiment described may include a particular feature, structure, or characteristic. Every embodiment, however, may not necessarily include the particular feature, structure, or characteristic. Thus, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The following detailed description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

The embodiments described herein make reference to a “media object.” Media objects include, but are not limited to, photographic images, digital videos, microblog and blog posts, audio files, documents, or any other type of digital media. A person of skill in the art will readily recognize the types of data that constitute media objects.

This Detailed Description is divided into sections. The first and second sections describe example system and method embodiments, respectively, that may be used to cluster one or more media objects received from various media sources. The third section describes an exemplary group of segments clustered by an embodiment. The fourth section describes an example computer system that may be used to implement the embodiments described herein.

### Example System Embodiments

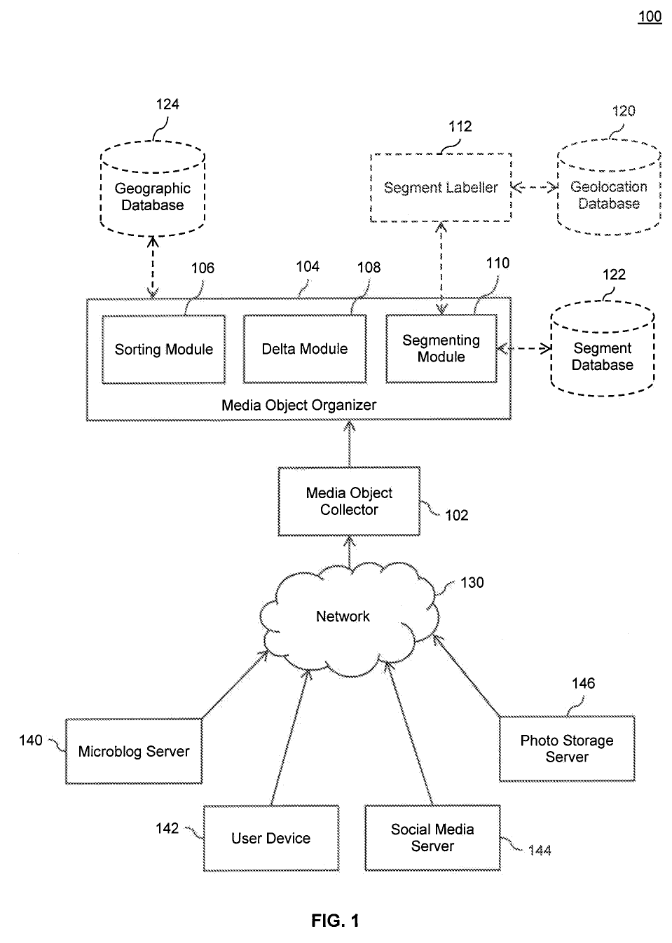

FIG. 1 illustrates example system environment 100 that may be used to cluster various types of media objects received from one or more media sources. System 100 includes media object collector 102, media object organizer 104, segment labeller 112, geolocation database 120, segment database 122, geographic database 124, network 130, microblog server 140, user device 142, social media server 144, and photo storage server 146. Media object organizer 104 includes sorting module 106, delta module 108, and segmenting module 110.

Network 130 can include any network or combination of networks that can carry data communication. These networks can include, for example, a local area network (LAN) or a wide area network (WAN), such as the Internet. LAN and WAN networks can include any combination of wired (e.g., Ethernet) or wireless (e.g., Wi-Fi, 3G, or 4G) network components.

Microblog server 140, user device 142, social media server 144, and photo storage server 146 can include any computing device capable of capturing, creating, storing, or transmitting media objects. These devices can include, for example, stationary computing devices (e.g., desktop computers), networked servers, and mobile computing devices such as, for example, tablets, smartphones, or other network enabled portable digital devices. Computing devices may also include, but are not limited to, a central processing unit, an application-specific integrated circuit, a computer, workstation, distributed computing system, computer cluster, embedded system, stand-alone electronic device, networked device, mobile device (e.g. mobile phone, smart phone, personal digital assistant (PDA), navigation device, tablet or mobile computing device), rack server, set-top box, or other type of computer system having at least one processor and memory. A computing process performed by a clustered computing environment or server farm may be carried out across multiple processors located at the same or different locations. Hardware can include, but is not limited to, a processor, memory and user interface display.

Media object collector 102, media object organizer 104, sorting module 106, delta module 108, segmenting module 110, segment labeller 112, geolocation database 120, segment database 122, and geographic database 124 can also run on any computing device. Each component, module, or database may further run on a distribution of computer devices or a single computer device.

A. Media Object Organizer

Media object organizer 104 processes media objects retrieved from various media sources. The processed media objects can be retrieved from any number of media sources such as, for example, microblog server 140, user device 142, social media server 144, or photo storage server 146. In some embodiments, the media objects are automatically retrieved from various media sources based on one or more user profiles. In some embodiments, one or more users can provide media objects directly to media object organizer 104. These embodiments are described in more detail with reference to media object collector 102, below.

Media object organizer 104 includes sorting module 106, delta module 108, and segmenting module 110. These modules, however, are not intended to limit the embodiments. Consequently, one of skill in the art will readily understand how the functionality described herein may be implemented by using one or more alternative modules or configurations.

1. Sorting Module

Media object organizer 104 includes sorting module 106. Sorting module 106 is configured to sort one or more media objects based on a time value associated with each media object. The time value represents when each corresponding media object was created. The time value may be included in metadata associated with each media object. In some embodiments, the time value includes separate date and time values. In some embodiments, the time value includes a value that indicates time based on a distinct starting date and time. In some embodiments, the time value may adjust automatically for time zones and locality specific changes such as, for example, daylight saving time.

The time value is normally determined based on when the media object is created. For example, if the media object is a photographic image, the time value will indicate when the photographic image is captured. If the media object is a microblog post, the time value will indicate when the post is received by, for example, microblog server 140, and added to a user's profile. A person of skill in the art will readily understand an appropriate time value for each type of media object. The time value may also be based on some other event such as, for example, when a media object is modified.

In some embodiments, sorting module 106 will sort the media object in chronological order from oldest to newest based on the time value. In some embodiments, sorting module 106 will sort the media objects in reverse chronological. In some embodiments, sorting module 106 will sort the media objects based on similar creation times distinct from the creation date. These embodiments are merely exemplary and are not intended to limit sorting module 106.

2. Delta Module

Media object organizer 104 also includes delta module 108. Delta module 108 is configured to determine a delta between each sorted media object. The delta is determined by calculating a distance value and a velocity value between adjacent media objects. In some embodiments, delta module 108 receives the sorted media objects directly from sorting module 106. In some embodiments, sorting module 106 stores the sorted media objects in local memory or a database that is accessible to delta module 108. In either embodiment, the sorted media objects may also be represented by a list showing the order of the sorted media objects and a location where each media object can be retrieved.

Once delta module 108 accesses the sorted media objects, it first calculates a distance value between adjacent media objects. The distance value between adjacent media objects is based on a difference between a geolocation associated with each adjacent media object. For example, a collection of sorted media objects may include object1, object2, object3, etc. Delta module 108 will determine a distance value between object1 and object2 as well as between object2 and objcet3. For larger collections of sorted media objects, the process is continued for each two adjacent media objects.

The geolocation associated with each media object can include, for example, latitude/longitude coordinates, addresses, or any other coordinate system. The geolocation can also include altitude values. In some embodiments, the geolocation for each media object is based on where the media object was created. For example, if the media object is a photographic image, the geolocation is based on where the image was captured. If the media object is an audio file, the geolocation is based on where the audio file was recorded. If the media object is a blog post, the geolocation is based on a user's location when creating the blog post. In some embodiments, the geolocation is set or modified based on user input.

In some embodiments, the geolocation is determined by a computer device used to create the media object. These computer devices can utilize location services such as, for example, global positioning system (GPS) services or a network based location service. In some embodiments, the geolocation is based on user input. In some embodiments, a combination of user input and a location service are utilized.

In some cases, not all media objects will include a geolocation. For these cases a number of methods may be used to compensate for media objects missing a geolocation. In some embodiments, each media object without a geolocation may copy a geolocation from an adjacent media object based on a difference between the time value. For example, if object2, described above, does not include a geolocation, it may utilize the geolocation from either object1 or object3, depending on which object was created within a shorter duration. If object1 and object3 have no geolocation, object 2 can utilize the geolocation from the next closest adjacent object with a geolocation. In some embodiments, delta module 108 may be configured to skip over media objects missing geolocations and determine a distance value only between the closest, adjacent media objects with a geolocation.

Once delta module 108 calculates a distance value between each adjacent media object, it calculates a velocity value. The velocity value is based on the difference between the time values and the geolocations associated with each two adjacent media objects. The velocity value is intended to show the speed at which a user travels between the geolocations associated with each two adjacent media object. For example, the distance value between object1 and object2 is 60 miles. The time difference between object1 and object2 is one hour. Thus the velocity value between object1 and object2 is 60 miles per hour. The velocity value may be represented in any appropriate format and is not limited to the foregoing example.

In some embodiments, a velocity value is used to determine a mode of transportation between adjacent media objects. For example, if a velocity value translates into a velocity over 100 miles per hour, the mode of transportation may be set to airplane. If the velocity value is between 20 miles per hour and 100 miles per hour, the mode of transportation may be set to automobile. If the velocity value is between 5 miles per hour and 20 miles per hour, the mode of transportation may be set to bicycle. If the velocity value is between 1 mile per hour and 5 miles per hour, the mode of transportation may be set to walking or hiking. If the velocity value is under 1 mile per hour, the mode of transportation may be set to mostly stationary. These limits may be modified to include other modes of transportation and are not intended to limit the embodiments in any way.

3. Segmenting Module

Media object organizer 104 further includes segmenting module 110. Segmenting module 110 is configured to cluster one or more sorted media objects into one or more segments based on the velocity value between adjacent media objects. The clustering process can occur after delta module 108 determines a velocity value between each adjacent media object. In some embodiments, the media objects are clustered into segments based on similar velocity values. In some embodiments, the media objects are clustered into segments based on velocity value ranges. For example, as segmenting module 110 scans the sorted media objects, it encounters a contiguous group of media objects with velocity values between 20 and 100 miles per hour. This group of media objects is clustered into a first segment. Segmenting module 110 then encounters a velocity value between two media objects that is 10 miles per hour. When this velocity value is encountered, segmenting module 110 will begin a new segment that will include adjacent contiguous media objects with velocity values between 5 and 20 miles per hour. This process will continue until each media object is included in a segment.

In some embodiments, segmenting module 110 is further configured to merge a first segment with an second segment when the geolocations associated with the media objects included in the first segment are determined to be inaccurate. For example, if a geolocation associated with a media object results in a velocity value that is inconsistent with neighboring velocity values, segmenting module 110 will merge the media object with a neighboring segment. If the resulting neighboring segments have velocity values within the same range, segmenting module 110 may also merge these segments.

In some embodiments, segmenting module 110 will store each segment in segment database 122 for further processing. Further processing of the segments may include, for example, organizing the segments into a digital movie. The digital movie may incorporate geographic data retrieved from geographic database 124.

B. Media Object Collector

Media object collector 102 is configured to receive media objects from one or more various media sources. It can be implemented by any computer device capable of receiving media objects from one or more media sources. In some embodiments, media object collector 102 receives a collection of media objects from a user. In some embodiments, media object collector 102 retrieves media objects from one or more media sources. For example, media sources can include, for example, microblog server 140, user device 142, social media server 144, and photo storage server 146. To retrieve media object from various media sources, media object collector 102 is configured to automatically access one or more user profiles for each media source. Media objects can then be retrieved from one or more user profiles based on a date and time range, a geolocation range, or an individual user's profile. The media objects are collected in a way that respect the privacy and sharing settings associated with the user profiles.

C. Segment Labeller

System 100 may optionally include segment labeller 112. Segment labeller is configured to label a segment or at least one media object in a segment based on a geolocation. Segment labeller 112 may utilize reverse geocoding to determine a label based on the geolocation. Labels can include, but are not limited to, location names, business names, political designations, addresses, coordinates, or any other label that can be determined based on reverse geocoding. Labels can be retrieved from a database such as, for example, geolocation database 122.

In some embodiments, segment labeller 112 is further configured to label a segment based on the geolocation associated with the first media object and the last media object included in the segment. For example, the first media object in a segment is created at a first geolocation and, after traveling in an airplane, the last media object is created in a second geolocation. Segment labeller 112 may utilize the first and second geolocations to derive a label that indicates airplane travel between the geolocations.

Various aspects of embodiments described herein can be implemented by software, firmware, hardware, or a combination thereof. The embodiments, or portions thereof, can also be implemented as computer-readable code. The embodiment in system 100 is not intended to be limiting in any way.

### Example Method Embodiments

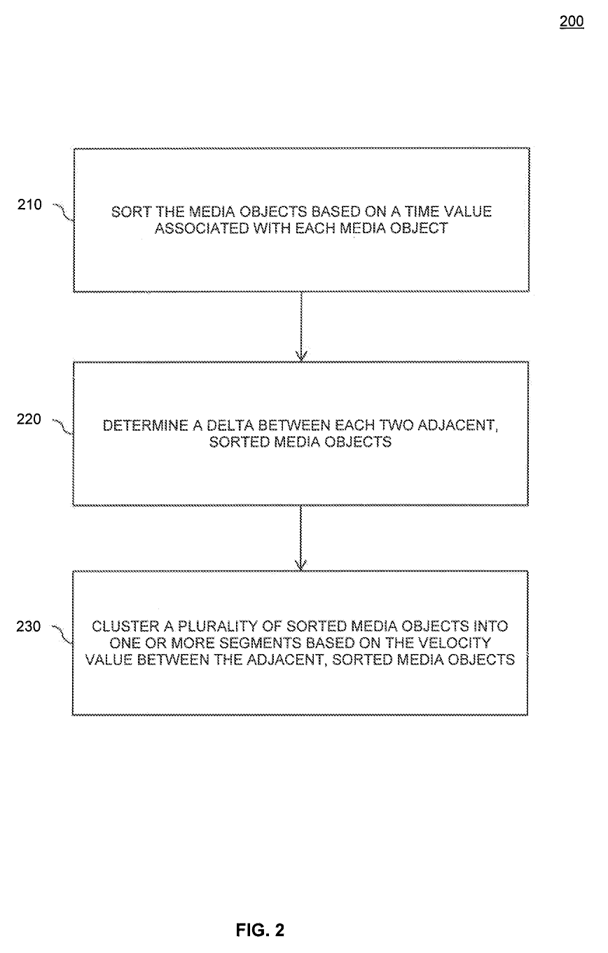

FIG. 2 is a flowchart illustrating exemplary method 200 that may be used to cluster various types of media objects received from one or more media sources. While method 200 is described with respect to an embodiment, method 200 is not meant to be limiting and may be used in other applications. Additionally, method 200 may be carried out by, for example, system 100.

Method 200 first sorts the media objects based on a time value associated with each media object (stage 210). The time value indicates when each media object was created. The time value may also indicate when a media object was last modified, copied, distributed, uploaded to a server, or any other event. The media objects may be sorted in several different ways such as, for example, chronological order, reverse chronological order, by time of day regardless of date, by date regardless of time, or any other order based on the time value. Stage 210 may be carried out by, for example, sorting module 106 embodied in system 100.

Method 200 then determines a delta between each two adjacent media object (stage 220). For example, if a sorted group of media objects includes object1, object2, and object3, a delta will be determined between object1 and object2 and object2 and object3. The delta is determined by calculating a distance value and a velocity value between adjacent media objects. The distance value is based on a difference between the geolocations associated with two adjacent media object. For example, the distance value between object1 and object2 will be based on the difference between the geolocations associated with object1 and object2. The velocity value represents the velocity of travel between media objects. It is calculated from the distance value and a difference between the time value associated with two adjacent media object. For example, the velocity value included between object1 and object2 will be based on the difference between the time values and the distance values associated with object1 and object2. Stage 220 may be carried out by, for example, delta module 108 embodied in system 100.

Once the delta between each adjacent media object is determined, method 200 clusters one or more of the sorted media objects into one or more segments based on velocity values (stage 230). In some embodiments, the velocity value between media objects can act as a break-point between segments. Whether a velocity value serves as a break-point is based on, for example, the velocity value falling outside a range of values that include neighboring velocity values. When a velocity value is determined to be a break-point, the media objects following the break-point are included in a new, separate segment. Stage 230 may be carried out by, for example, segmenting module 110 embodied in system 100.

In some embodiments, media objects are clustered into segments based on the similarity between velocity values. For example, if the velocity value between object1 and object2 is similar to the velocity value between object2 and object3, all three objects are included in the same segment.

In some embodiments, media objects are clustered into segments based on a range of velocity values. For example, if the velocity value between object1 and object2 is 400 miles per hour and the velocity value between object2 and object3 is 40 miles per hour, object3 is clustered into a segment separate from object1 and object2.

In some embodiments, segments are clustered based on the velocity value and the time value. For example, if the velocity value between object1 and object2 is 400 miles per hour but object2's time value is one day ahead, object2 may be included in a separate segment.

### Example Media Segments

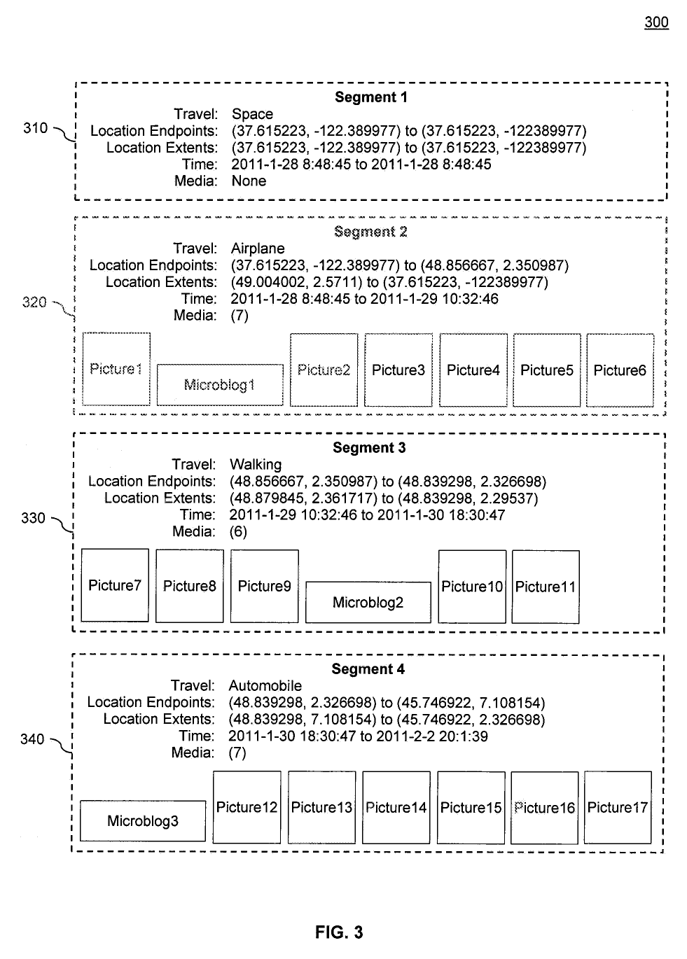

FIG. 3 illustrates an exemplary group of segments 300 resulting from. clustering media objects according to an embodiment. Segment group 300 includes segment 310, segment 320, segment 330, and segment 340. Each segment is clustered based on the velocity value between each media object falling into one or more ranges of values. Segment group 300 includes media objects picture1 though picture17 and microblog1 through microblog3. Picture1 through picture17 were collected from user device 142, social media server 144, and photo storage server 146. Micorblog1 through microblog3 were collected from microblog server 140. The media objects are sorted based on when they were created by one or more users.

After the media objects are sorted based on creation times, a distance value and a velocity value are determined between each adjacent, sorted media object. The media objects are then clustered into segments based on the velocity value between each adjacent media object. Segment 310 is a default segment that may be included in some embodiments. It is intended to be used as a starting point for a digital video that incorporates the segment group 300. Segment 320 includes the media objects with by velocity values above 100 miles per hour. This velocity value range indicates that an airplane was the most likely mode of transportation. Segment 330 includes the media objects with by velocity values between 1 mile per hour and 5 miles per hour. This velocity value range indicates that walking was the most likely mode of transportation. Segment 340 includes media objects with by velocity values between 20 miles per hour and 100 miles per hour. This velocity value range indicates that an automobile was the most likely mode of transportation.

Segments 300 is provided as an example and is not intended to limit the embodiments described herein.

### Example Computer System

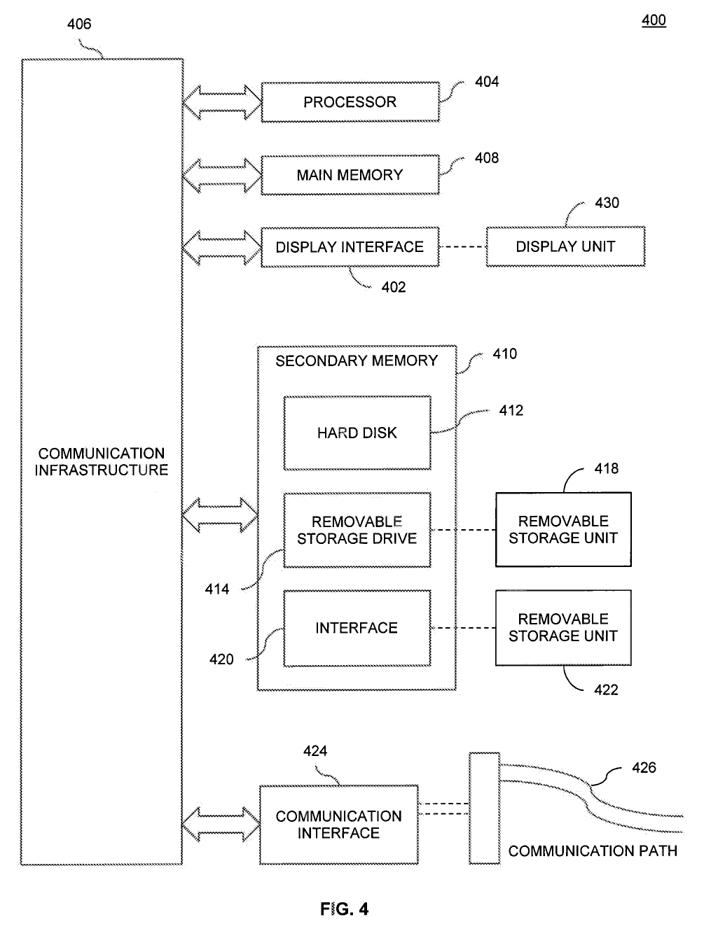

FIG. 4 illustrates an example computer system 400 in which embodiments of the present disclosure, or portions thereof, may be implemented. For example, sorting module 106, delta module 108, and segmenting module 110 may be implemented in one or more computer systems 400 using hardware, software, firmware, computer readable storage media having instructions stored thereon, or a combination thereof.

One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above described embodiments. A processor device may be a single processor, a plurality of processors, or combinations thereof. Processor devices may have one or more processor “cores.”

Various embodiments are described in terms of this example computer system 400. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 404 may be a single processor in a multi-core/multiprocessor system, such system operating alone, or in a cluster of computing devices operating in a cluster or server farm. Processor device 404 is connected to a communication infrastructure 406, for example, a bus, message queue, network, or multi-core message-passing scheme.

Computer system 400 also includes a main memory 408, for example, random access memory (RAM), and may also include a secondary memory 410. Secondary memory 410 may include, for example, a hard disk drive 412, and removable storage drive 414. Removable storage drive 414 may include a floppy disk drive, a magnetic tape drive, an optical disk drive, a flash memory drive, or the like. The removable storage drive 414 reads from and/or writes to a removable storage unit 418 in a well-known manner. Removable storage unit 418 may include a floppy disk, magnetic tape, optical disk, flash memory drive, etc. which is read by and written to by removable storage drive 414. As will be appreciated by persons skilled in the relevant art, removable storage unit 418 includes a computer readable storage medium having stored thereon computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Communications interface 424 may include a modem, a network interface (such as an Ethernet card), a communications port, a PCMCIA slot and card, or the like. Software and data transferred via communications interface 424 may be in the form of signals, which may be electronic, electromagnetic, optical, or other signals capable of being received by communications interface 424. These signals may be provided to communications interface 424 via a communications path 426. Communications path 426 carries signals and may be implemented using wire or cable, fiber optics, a phone line, a cellular phone link, an RF link or other communications channels.

In this document, the terms “computer storage medium” and “computer readable storage medium” are used to generally refer to media such as removable storage unit 418, removable storage unit 422, and a hard disk installed in hard disk drive 412. Computer storage medium and computer readable storage medium may also refer to memories, such as main memory 408 and secondary memory 410, which may be memory semiconductors (e.g. DRAMs, etc.).

Computer programs (also called computer control logic) are stored in main memory 408 and/or secondary memory 410. Computer programs may also be received via communications interface 424. Such computer programs, when executed, enable computer system 400 to implement the embodiments described herein. In particular, the computer programs, when executed, enable processor device 404 to implement the processes of the embodiments, such as the stages in the methods illustrated by flowchart 200 of FIG. 2, discussed above. Accordingly, such computer programs represent controllers of computer system 400. Where an embodiment is implemented using software, the software may be stored in a computer storage medium and loaded into computer system 400 using removable storage drive 414, interface 420, and hard disk drive 412, or communications interface 424.

Embodiments of the invention also may be directed to computer program products including software stored on any computer readable storage medium. Such software, when executed in one or more data processing device, causes a data processing device(s) to operate as described herein. Examples of computer readable storage mediums include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

### Conclusion

The Summary and Abstract sections may set forth one or more but not all exemplary embodiments as contemplated by the inventor(s), and thus, are not intended to limit the present invention and the appended claims in any way.

The foregoing description of specific embodiments so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

1. A computer-implemented method for clustering various types of media objects received from one or more media sources comprising:
sorting, by one or more computing device, the media objects based on a time value associated with each media object, wherein the time value represents when each corresponding media object was created;
determining, by the one or more computing device, a delta between each two adjacent, sorted media objects, wherein the delta includes:
a distance value that represents a difference between a geolocation associated with each two adjacent media objects and
a velocity value that represents a speed of travel between the geolocations associated with each two adjacent media objects calculated using the distance value relative to a difference between the time values associated with each two adjacent media objects;
determining a mode of transportation between each two adjacent media objects based on the velocity value between the adjacent, sorted, media objects falling within a velocity range, the mode of transportation being associated with one of flying, driving, walking, boating, biking, or remaining stationary;
clustering, by the one or more computing device, a plurality of sorted media objects into a plurality of segments based on the mode of transportation between the adjacent, sorted media objects;
identifying, within a first segment, a media object having one or more inaccurate geo-locations relative to other media objects in the first segment; and
merging the identified media objects with a second segment based at least in part on the identification of the one or more inaccurate geo-locations.

2. (canceled)

3. The computer-implemented method of claim 1, further comprising:
labeling a segment based on the geolocation associated with at least one media object included in the segment.

4. The computer-implemented method of claim 3, wherein labeling a segment is further based on the geolocation associated with a first media object and a last media object included in the segment.

5. The computer-implemented method of claim 1, further comprising:
labeling at least one media object included in a segment based on the geolocation associated with the at least one media object.

6-7. (canceled)

8. The computer-implemented method of claim 1, wherein the clustering is further based on the velocity values falling within a velocity range.

9. A system for clustering various types of media objects received from one or more media sources comprising:
a computing device comprising a processor and memory;
a sorting module implemented on the computing device, and configured to sort the media objects based on a time value associated with each media object, wherein the time value represents when each corresponding media object was created;
a delta module, implemented on the computing device, and configured to determine a delta between each two adjacent, sorted media objects, wherein the delta includes:
a distance value that represents a difference between a geolocation associated with each two adjacent media objects and
a velocity value that represents a speed and a direction of travel between the geolocation associated with each two adjacent media objects, the velocity value calculated using the distance value relative to a difference between the time value associated with each two adjacent media objects;
a segmenting module, implemented on the computing device, and configured to determine a mode of transportation between each two adjacent media objects based on the velocity value between the adjacent, sorted, media objects falling within a velocity range, the mode of transportation being associated with one of flying, driving, walking, boating, biking, or remaining stationary, the segmenting module further configured to cluster a plurality of sorted media objects into one or more segments based on the mode of transportation between the adjacent, sorted media objects, the clustering comprising determining one or more break points at which to end a current segment, the one or more break points being determined based at least in part on whether a velocity of a media object falls outside of a range of velocity values associated with the current segment, the range of velocity values being determined based at least in part on a mode of transportation associated with the current segment;
wherein the segmenting module is further configured to:
identify, within a first segment, a media object having one or more inaccurate geo-locations relative to other media objects in the first segment; and
merge the identified media objects with a second segment based at least in part on the identification of the one or more inaccurate geo-locations.

10. (canceled)

11. The system of claim 9, further comprising:
a segment labeler, implemented on the computing device, and configured to label a segment based on the geolocation associated with at least one media object included in the segment.

12. The system of claim 11, wherein the segment labeller is further configured to label a segment based on the geolocation associated with a first media object and a last media object included in the segment.

13. The system of claim 9, further comprising:
a segment labeller configured to label at least one media object included in a segment based on the geolocation associated with the at least one media object.

14-15. (canceled)

16. The system of claim 9, wherein the segmenting module is further configured to cluster the media objects based on the velocity values falling within a velocity range.

17. A non-transitory computer-readable storage medium having instructions encoded thereon that, when executed by a computing device, causes the computing device to perform operations comprising:
sorting the media objects based on a time value associated with each media object, wherein the time value represents when each corresponding media object was created;
determining a delta between each two adjacent, sorted media objects, wherein the delta includes:
a distance value that represents a difference between a geolocation associated with each two adjacent media objects and
a velocity value that represents a speed of travel between the geolocation associated with each two adjacent media objects, the velocity value calculated using the distance value relative to a difference between the time value associated with each two adjacent media objects;
determining a mode of transportation between each two adjacent media objects based on the velocity value between the adjacent, sorted, media objects falling within a velocity range, the mode of transportation being associated with one of flying, driving, walking, boating, biking, or remaining stationary;
clustering a plurality of sorted media objects into one or more segments based on the mode of transportation between the adjacent, sorted media objects, the clustering comprising determining one or more break points at which to end a current segment, the one or more break points being determined based at least in part on whether a velocity of a media object falls outside of a range of velocity values associated with the current segment, the range of velocity values being determined based at least in part on a mode of transportation associated with the current segment;
identifying, within a first segment, a media object having one or more inaccurate geo-locations relative to other media objects in the first segment; and
merging the identified media objects with a second segment based at least in part on the identification of the one or more inaccurate geo-locations.

18. (canceled)

19. The computer-readable storage medium of claim 17, further comprising:
labeling a segment based on the geolocation associated with at least one media object included in the segment.

20. The computer-readable storage medium of claim 19, wherein labeling a segment is further based on the geolocation associated with a first media object and a last media object included in the segment.

21. The computer-readable storage medium of claim 17, further comprising:
labeling at least one media object included in a segment based on the geolocation associated with the at least one media object.

22-23. (canceled)

24. The computer-readable storage medium of claim 17, wherein the clustering is further based on the velocity values falling within a velocity range.
